(19) United States
(12) Patent Application Publication
(10) Pub. No.: US 2008/0152437 A1
(43) Pub. Date: Jun. 26, 2008

(54) PULVERULENT MATERIAL TRANSPORT

(75) Inventors: Christopher R. Merritt, Noblesville, IN (US); Michael J. Thies, Indianapolis, IN (US)

Correspondence Address: BARNES & THORNBURG LLP, 11 SOUTH MERIDIAN, INDIANAPOLIS, IN, 46204, US

(73) Assignee: ILLINOIS TOOL WORKS INC., Glenview, IL (US)

(21) Appl. No.: 11/936,374

(22) Filed: Nov. 7, 2007

Related U.S. Application Data
(60) Provisional application No. 60/871,846, filed on Dec. 26, 2006.

(51) Int. Cl. B65G 53/26

(52) U.S. Cl. 406/39; 406/134; 406/139; 406/141

(57) ABSTRACT

An apparatus for transporting powder from a powder container is adapted to engage a wall of the powder container. The apparatus is adapted to support a pickup tube with a region of the pickup tube through which powder is picked up from the powder container adjacent the lowermost interior region of the powder container.

### CROSS-REFERENCE TO RELATED APPLICATIONS

This application claims the benefit of the Dec. 26, 2006 filing date of U.S. Ser. No. 60/871,846. The complete disclosure of U.S. Ser. No. 60/871,846 is hereby incorporated herein by reference.

### FIELD OF THE INVENTION

This invention relates to apparatus and methods for the transport of pulverulent materials, hereinafter sometimes referred to as powder. It is disclosed in the context of powders which are used to coat articles. Such powders are hereinafter sometimes described as coating powders, powder coating materials, or similar terms. While the invention is disclosed in the context of various types of powder container unloaders, it should be understood that it is applicable to any type of powder container unloader, such as vibrator tables, tilt carts, and so on, to any type of powder container, such as powder boxes, bulk drums, and so on, and to powder transports of any type, such as dense phase pumps, venturi-style vacuum pumps, diaphragm pumps, and so on.

### BACKGROUND OF THE INVENTION

Various types of powder coating equipment are known. There are, for example, the systems illustrated and described in the following listed U. S. Patents and published applications, and in the prior art cited therein: 2004/0174862; 2005/0207901; 2006/0159565; 2006/0185586; U.S. Pat. Nos. 4,744,701; 5,199,989; 5,215,261; 5,240,185; 5,271,695; 5,323,547; 5,335,828; 5,351,520; 5,473,947; 5,518,344; 5,662,772; 5,690,450; 5,768,800; 5,800,876; 6,432,173; 6,669,780; 6,878,205; and, 6,908,048; in WO 2006/084253, EP 1 454 675 A2 and DE 103 53 968; and in ITW Gema FPP01 Fresh Powder Pump Operating Instructions And Spare Parts List, November, 2004. The disclosures of all of those references are hereby incorporated herein by reference. These listings are not intended to be representations that a complete search of all relevant art has been made, or that no more pertinent art than that listed exists, or that the listed art is material to patentability. Nor should any such representation be inferred.

### DISCLOSURE OF THE INVENTION

According to an aspect of the invention, apparatus for transporting powder is adapted to engage a wall of a powder container. The apparatus is further adapted to support a pickup tube with a region of the pickup tube through which powder is picked up from the powder container adjacent a lowermost interior region of the powder container.

Illustratively, the apparatus includes movable jaws spring-urged to a closed orientation. The jaws are separable against the urging of the spring to mount the device on the wall.

Illustratively, the apparatus includes a first leg and a second leg. The second leg defines an opening having a dimension for receiving the wall in such a manner as to support the pickup tube with a region of the pickup tube through which powder is picked up from the powder container adjacent a lowermost interior region of the powder container.

Illustratively, the apparatus further includes a vibrator for vibrating the powder container to aid in migration of powder to the lowermost interior region.

Illustratively, the apparatus further includes a powder container unloader cart adapted to receive the powder container and to orient the powder container in a tilted orientation with the lowermost interior region adjacent the region of the pickup tube through which powder is picked up from the powder container. Illustratively, the apparatus further includes a vibrator for vibrating the powder container while the powder container is maintained in a tilted orientation to aid in migration of powder to the lowermost interior region.

Illustratively, the apparatus includes an arm adapted to extend from the wall of the powder container when the apparatus engages the wall. The arm is adapted to engage the pickup tube to orient the pickup tube generally vertically with the region of the pickup tube through which powder is picked up from powder container adjacent the lowermost interior region. Illustratively, the arm includes an opening for slidably receiving the pickup tube.

Illustratively, the apparatus includes first and second movable jaws and a threaded shaft extending between the first and second jaws. The threaded shaft is manipulable to clamp the wall between the first and second jaws.

Illustratively, the apparatus includes first and second movable jaws and an arm adapted to extend from a first one of the movable jaws. The arm is adapted to engage the pickup tube to orient the pickup tube in the powder container. The arm is pivotally mounted to the first one of the movable jaws.

Illustratively, the apparatus includes first and second movable jaws and an arm adapted to extend from a first one of the movable jaws. The arm includes a slot-shaped opening for receiving the pickup tube to orient the pickup tube adjustably along the slot-shaped opening in the powder container.

According to another aspect of the invention, a combination includes a powder container unloader cart adapted to hold a powder container in a tilted orientation providing a lowermost interior region of the container and an apparatus for transporting powder from the powder container. The apparatus is adapted to engage a wall of the powder container. The apparatus is adapted to support a pickup tube with a region of the pickup tube through which powder is picked up from the powder container adjacent the lowermost interior region of the powder container.

Illustratively, the powder container unloader cart further includes a vibrator for vibrating the powder container to aid in migration of powder to the lowermost interior region.

Illustratively, the apparatus for transporting powder from the powder container includes an arm adapted to extend from the wall of the powder container when the apparatus engages the wall. The arm is adapted to engage the pickup tube to orient the pickup tube with the region of the pickup tube through which powder is picked up from the powder container adjacent the lowermost interior region.

Illustratively, the arm includes an opening for slidably receiving the pickup tube.

Illustratively, the apparatus includes first and second movable jaws and a threaded shaft extending between the first and second jaws. The threaded shaft is manipulable to clamp the wall between the first and second jaws.

Illustratively, the apparatus includes first and second movable jaws and an arm adapted to extend from one of the movable jaws. The arm is adapted to engage the pickup tube to orient the pickup tube in the powder container. The arm is pivotally mounted to said one of the movable jaws.

Illustratively, the apparatus includes first and second movable jaws and an arm adapted to extend from one of the movable jaws. The arm includes a slot-shaped opening for receiving the pickup tube to orient the pickup tube adjustably along the slot-shaped opening.

Illustratively, the apparatus includes movable jaws spring-urged to a closed orientation. The jaws are separable against the urging of the spring to mount the device on the wall.

Illustratively, the apparatus includes a first leg and a second leg. The second leg defines an opening having a dimension for receiving the wall in such a manner as to support the pickup tube with a region of the pickup tube through which powder is picked up from the powder container adjacent a lowermost interior region of the powder container.

### BRIEF DESCRIPTIONS OF THE DRAWINGS

The invention may best be understood by referring to the following detailed descriptions and accompanying drawings which illustrate the invention. In the drawings:

FIG. 1 illustrates a partly fragmentary perspective view of a system constructed according to the invention;

FIG. 2 illustrates an enlarged partly fragmentary detail of the system illustrated in FIG. 1;

FIG. 3 illustrates a partly fragmentary perspective view of a system constructed according to the invention;

FIG. 4 illustrates an enlarged partly fragmentary detail of the system illustrated in FIG. 3;

FIG. 5 illustrates a partly fragmentary perspective view of a system constructed according to the invention;

FIG. 6 illustrates an enlarged partly fragmentary detail of the system illustrated in FIG. 5;

FIG. 7 illustrates an alternative enlarged partly fragmentary detail to the details illustrated in FIGS. 2, 4 and 6; and,

FIG. 8 illustrates an alternative enlarged partly fragmentary detail to the details illustrated in FIGS. 2, 4, 6 and 7.

### DETAILED DESCRIPTIONS OF ILLUSTRATIVE EMBODIMENTS

A typical powder container unloader cart 20 orients the powder container 22 in a tilted orientation, at an angle θ, usually along an edge 24 or at a corner 26 of the container 22. This is done to urge the powder toward a lowest point 24 or 26 in the container 22, where it can be conveniently transported from the container 22 to a coating dispensing device 28, hereinafter sometimes a powder gun, to be dispensed onto an article to be coated by the dispensed powder. Often, such carts 20 are provided with vibrators 30 for vibrating the tilted containers 22 to enhance the flow of the powder to the lowest point 24 or 26 in the container 22.

Such carts 20 typically are also provided with pickup tubes 32 including powder pumps 34, for example, pumps of the venturi type that induce a flow of air adjacent (a) port(s) 36 at or near the lower end 38 of the pickup tube 32. The air entrains powder and transports the powder to the gun 28 to be dispensed onto articles to be coated. Typically, the pickup tubes 32 are slidably mounted on the carts 20 so that the pickup tubes 32 can follow the level of the powder in the powder containers 22 as the containers 22 are emptied, and can be raised to facilitate removal/replacement of powder containers 22 on the carts 20 and then lowered into the replacement containers 22 to facilitate powder pickup and transport.

Typical powder containers 22 are constructed from, for example, corrugated boxboard and/or other materials that are sufficiently rigid to withstand shipping and handling with few or no deleterious effects. According to the invention, the mounting of the pickup tube 32 on the cart 20 is eliminated. This takes advantage of the relatively robust construction of typical powder containers 22 and simplifies the construction and operation of the powder container unloader cart 20.

The invention includes a device 40 for engaging a wall 42 of the powder container 22. The device 40 includes an arm 44 which projects outward from the wall 42 over the interior of the powder container 22 when the device 40 is properly oriented on the powder container 22. The arm 44 includes an opening 46 for receiving the pickup tube 32. In this way, the device 40, either with or without the pickup tube 32 attached, can be readily removed from, for example, an empty powder container 22, temporarily put aside, a replacement powder container 22 positioned on the cart 20, and the device 40 placed on the wall 42 of the replacement powder container 22. If the pickup tube 32 is fixed to the arm 44, placement of the device 40 fixes the lower, pickup end 38 of the pickup tube 32 adjacent the lowermost region 24, 26 of the replacement powder container 22. If the pickup tube 32 is slidably mounted on the arm 44, the pickup tube 32 can then be slid into appropriate position to facilitate pickup of the powder from the replacement powder container 22.

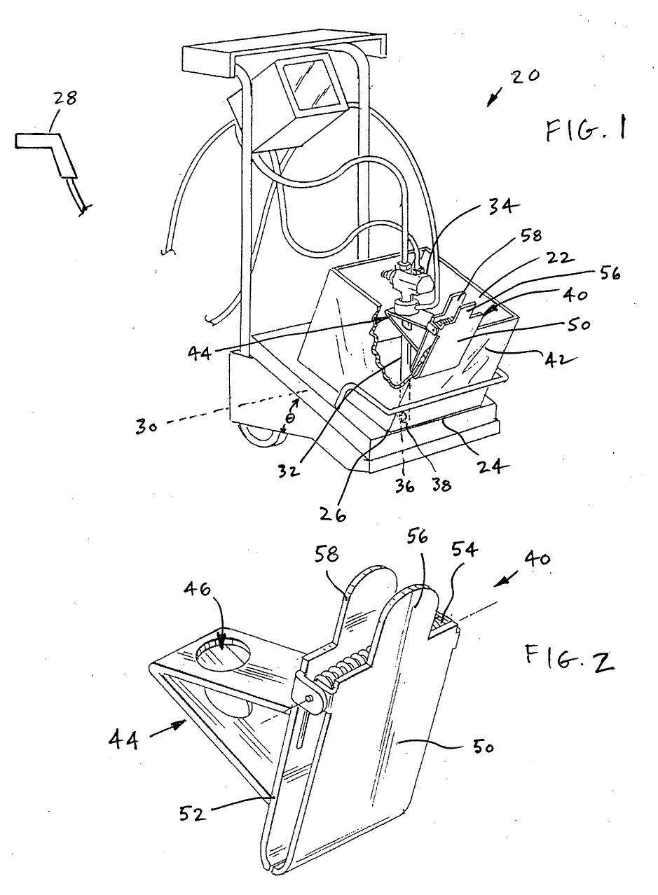

In the embodiment illustrated in FIGS. 1-2, the device 40 comprises a clip, the pivotally coupled jaws 50, 52 of which are spring 54-urged to a closed orientation. The handles 56, 58 of the clip 40 are squeezed together, somewhat the way a clothespin would be, separating the jaws 50, 52 of the clip 40 and permitting the jaws 50, 52 to be placed around a wall 42 of the powder container 22 at a convenient location. The handles 56, 58 of the clip 40 are then released, capturing the wall 42 between the jaws 50, 52 and fixing the position of the arm 44 and the pickup tube 32 which is either fixed or slidably mounted in opening 46 in the arm 44. In the former event, the placement of the clip 40 at the appropriate location locates the lower end 38 of the pickup tube 32 adjacent the lowermost point 24, 26 in the container 22 when the container 22 is properly oriented on the cart 20. In the latter event, the pickup tube 32 is then slid downward until the lower end 38 of the pickup tube 32 is properly oriented adjacent the lowermost point 24, 26 in the container 22 when the container 22 is properly oriented on the cart 20.

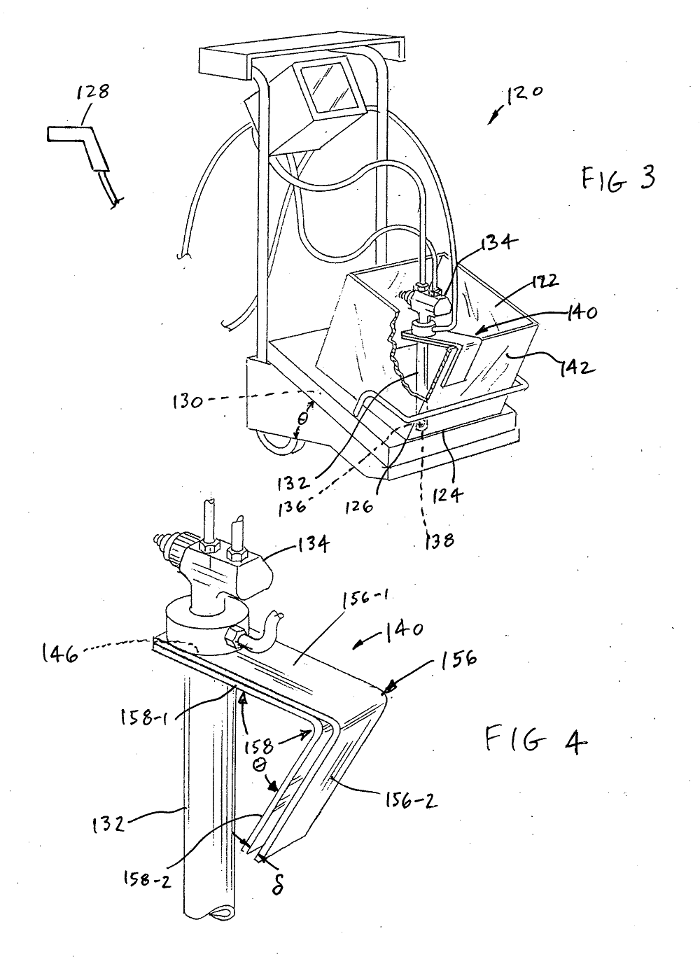

In another embodiment illustrated in FIGS. 3-4, many of the components are numbered the same as the components illustrated in FIGS. 1-2, but with the addition of a prefix “1.” Thus, 20 becomes 120, and so on. In the embodiment illustrated in FIGS. 3-4, the device 140 includes two somewhat “V” shaped strips 156, 158, the legs 156-1, 156-2; 158-1, 158-2 of each of which make with each other an acute angle θ. Typically, this angle θ illustratively is the same as the angle θ to which the bottom of the powder container 122 is tilted when the powder container 122 is placed on the cart 120. Corresponding legs 156-1, 158-1 of the two strips are fixed together, for example, by welding, with the other corresponding legs 156-2, 158-2 of the two strips 156, 158 in spaced orientation. The space δ between the spaced legs 156-2, 158-2 illustratively is the thickness δ of the wall 142 of the powder container 122 onto which the device 140 is to be mounted. When the powder container 122 is appropriately positioned on the cart 120, the spaced legs 156-2, 158-2 of the device 140 are slid downward, one on each of two opposite sides of this wall 142, capturing the wall 142 between spaced legs 156-2, 158-2 and mounting the device 140 on wall 142. If the pickup tube 132 is fixed to the joined legs 156-1, 158-1 of the device 140, then the lower end 138 of the pickup tube 132 is properly oriented adjacent the lowermost point 124, 126 in the container 122. If the pickup tube 132 is slidable in the opening 146, then the pickup tube 132 is slid in the opening 146 until the lower end 138 of the pickup tube 132 is properly oriented adjacent the lowermost point 124, 126 in the container 122.

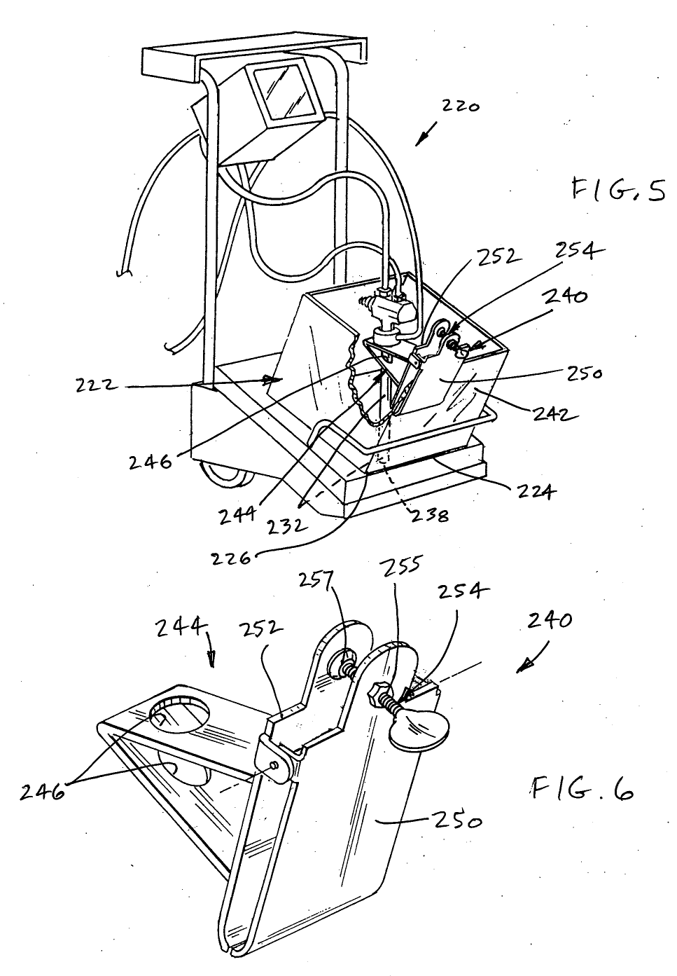

In another embodiment illustrated in FIGS. 5-6, many of the components are numbered the same as the components illustrated in FIGS. 1-2, but with the addition of a prefix “2.” Thus, 20 becomes 220, and so on. In the embodiment illustrated in FIGS. 5-6, the device 240 comprises a clip, the pivotally coupled jaws 250, 252 of which are urged to a closed orientation by a threaded device 254, such as a thumbscrew, which passes through a threaded opening 255 provided on jaw 250. The remote end 257 of device 254 presses against the inside surface of jaw 252, capturing the wall 242 between the jaws 250, 252 and fixing the position of the arm 244 and the pickup tube 232 which is either fixed or slidably mounted in openings 246 in the arm 244. In the former event, the placement of the clip 240 at the appropriate location locates the lower end 238 of the pickup tube 232 adjacent the lowermost point 224, 226 in the container 222 when the container 222 is properly oriented on the cart 220. In the latter event, the pickup tube 232 is then slid downward until the lower end 238 of the pickup tube 232 is properly oriented adjacent the lowermost point 224, 226 in the container 222 when the container 222 is properly oriented on the cart 220.

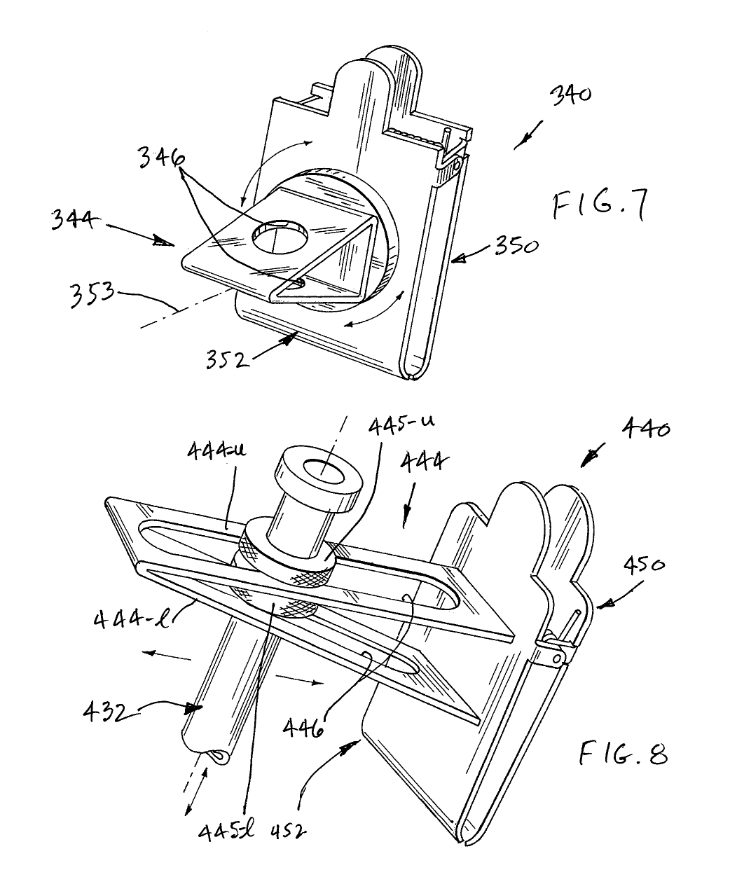

In another embodiment illustrated in FIG. 7, many of the components are numbered the same as the components illustrated in FIGS. 1-2, but with the addition of a prefix “3.” Thus, 20 becomes 320, and so on. In the embodiment illustrated in FIG. 7, the device 340 comprises a clip, the pivotally coupled jaws 350, 352 of which are urged to a closed orientation, and an arm 344 which projects into the interior of a powder container (not shown) when the device 340 is properly oriented on the powder container. The arm 344 includes openings 346 for receiving a pickup tube (not shown). In this embodiment, the arm 344 is pivotally attached to jaw 352 so that the pickup tube can be pivoted about the axis 353 of the attachment of arm 344 to jaw 352 to change the angle at which the pickup tube projecting through openings 346 enters the powder container. This facilitates, for example, placement of the device 340 on any side of a conventional powder box when the conventional powder box is placed on a cart of the type illustrated in FIGS. 1, 3 and 5.

In another embodiment illustrated in FIG. 8, many of the components are numbered the same as the components illustrated in FIGS. 1-2, but with the addition of a prefix “4.” Thus, 20 becomes 420, and so on. In the embodiment illustrated in FIG. 8, the device 440 comprises a clip, the pivotally coupled jaws 450, 452 of which are urged to a closed orientation, and an arm 444 which projects into the interior of a powder container (not shown) when the device 440 is properly oriented on the powder container. The arm 444 includes openings 446 for receiving a pickup tube 432. In this embodiment, the openings 446 are in the shape of slots which extend lengthwise of the upper and lower portions 444-u and 444-f of arm 444. The pickup tube 432 is coupled to arm 444 by a two-component threaded chuck 445-u, 445-f or the like which may be loosened to permit the pickup tube 432 to be positioned closer to jaw 452 or further from jaw 452 as necessary or desirable, as well as to raise or lower the lower pickup end of pickup tube 432 in the powder container to which device 440 is attached as necessary or desirable to facilitate extraction of powder from the powder container.

What is claimed is:

1. Apparatus for transporting powder, the apparatus adapted to engage a wall of a powder container, the apparatus adapted to support a pickup tube with a region of the pickup tube through which powder is picked up from the powder container adjacent a lowermost interior region of the powder container.

2. The apparatus of claim 1 including movable jaws spring-urged to a closed orientation, the jaws being separable against the urging of the spring to mount the device on the wall.

3. The apparatus of claim 1 including a first leg and a second leg, the second leg defining an opening having a dimension for receiving the wall in such a manner as to support the pickup tube with a region of the pickup tube through which powder is picked up from the powder container adjacent a lowermost interior region of the powder container.

4. The apparatus of claim 1 further including a vibrator for vibrating the powder container to aid in migration of powder to the lowermost interior region.

5. The apparatus of claim 1 further including a powder container unloader cart adapted to receive the powder container and to orient the powder container in a tilted orientation with the lowermost interior region adjacent the region of the pickup tube through which powder is picked up from the powder container.

6. The apparatus of claim 5 further including a vibrator for vibrating the powder container while the powder container is maintained in a tilted orientation to aid in migration of powder to the lowermost interior region.

7. The apparatus of claim 5 including an arm adapted to extend from the wall of the powder container when the apparatus engages the wall, the arm adapted to engage the pickup tube to orient the pickup tube generally vertically with the region of the pickup tube through which powder is picked up from powder container adjacent the lowermost interior region.

8. The apparatus of claim 7 wherein the arm includes an opening for slidably receiving the pickup tube.

9. The apparatus of claim 1 including first and second movable jaws and a threaded shaft extending between the first and second jaws, the threaded shaft being manipulable to clamp the wall between the first and second jaws.

10. The apparatus of claim 1 including first and second movable jaws and an arm adapted to extend from a first one of the movable jaws, the arm adapted to engage the pickup tube to orient the pickup tube in the powder container, the arm being pivotally mounted to the first one of the movable jaws.

11. The apparatus of claim 1 including first and second movable jaws and an arm adapted to extend from a first one of the movable jaws, the arm including a slot-shaped opening for receiving the pickup tube to orient the pickup tube adjustably along the slot-shaped opening.

12. In combination, powder container unloader cart adapted to hold a powder container in a tilted orientation providing a lowermost interior region of the container, and an apparatus for transporting powder from the powder container, the apparatus adapted to engage a wall of the powder container, the apparatus adapted to support a pickup tube with a region of the pickup tube through which powder is picked up from the powder container adjacent the lowermost interior region of the powder container.

13. The combination of claim 12 wherein the powder container unloader cart further includes a vibrator for vibrating the powder container to aid in migration of powder to the lowermost interior region.

14. The combination of claim 12 wherein the apparatus for transporting powder from the powder container includes an arm adapted to extend from the wall of the powder container when the apparatus engages the wall, the arm adapted to engage the pickup tube to orient the pickup tube with the region of the pickup tube through which powder is picked up from the powder container adjacent the lowermost interior region.

15. The combination of claim 14 wherein the arm includes an opening for slidably receiving the pickup tube.

16. The combination of claim 12 including first and second movable jaws and a threaded shaft extending between the first and second jaws, the threaded shaft being manipulable to clamp the wall between the first and second jaws.

17. The combination of claim 12 including first and second movable jaws and an arm adapted to extend from one of the movable jaws, the arm adapted to engage the pickup tube to orient the pickup tube in the powder container, the arm being pivotally mounted to said one of the movable jaws.

18. The combination of claim 12 including first and second movable jaws and an arm adapted to extend from one of the movable jaws, the arm including a slot-shaped opening for receiving the pickup tube to orient the pickup tube adjustably along the slot-shaped opening.

19. The combination of claim 12 including movable jaws spring-urged to a closed orientation, the jaws being separable against the urging of the spring to mount the device on the wall.

20. The combination of claim 12 wherein the apparatus includes a first leg and a second leg, the second leg defining an opening having a dimension for receiving the wall in such a manner as to support the pickup tube with a region of the pickup tube through which powder is picked up from the powder container adjacent a lowermost interior region of the powder container.
